(19) United States
(12) Patent Application Publication
(10) Pub. No.: US 2001/0022125 A1
(43) Pub. Date: Sep. 20, 2001

(54) AUTOMATIC HANDLE END CUTTER

(76) Inventors: CHARLES BLOCK, NORTH BELLMORE, NY (US); GEORGE GIBBS, WESTBURY, NY (US)

Correspondence Address: PAUL J SUTTON, REID & PRIEST, 40 WEST 57TH STREET, RM 2910, NEW YORK, NY, 10019

(21) Appl. No.: 09/037,467

(22) Filed: Mar. 10, 1998

(51) Int. Cl. B26D 7/02

(52) U.S. Cl. 83/452; 83/614

(57) ABSTRACT

An automatic handle end cutter to cut individual handles from a web of handle material. A shuttle clamp grips the web and advances it into a cutting area at which time the web is held by two further clamps. The shuttle clamp withdraws and a first cutter cuts the web at an angle to the longitudinal axis of the handle. This is followed by a second cutter which cuts the web at an angle to the handle axis giving handle ends with the corners removed. The severed and configured end handle is ejected and the cycle begun again.

### BACKGROUND OF THE INVENTION

1. Field of the Invention

The invention is directed to the field of mattress construction and more particularly to preparing cloth handles for attachment to a mattress border.

2. Description of the Prior Art

Cloth handles presently used in mattress construction are made up of a single layer of material and a foam layer formed into a tube shape and stitched along a central longitudinal axis and severed transverse to such axis leaving open ends. These ends present a unsightly, unfinished appearance and can also unravel. One manner of finishing the ends is to bend them under so as to be below portions of the main handle body. However, if the bent under end does not fully lie under the handle body, as where a corner extends beyond the handle body, the desired finished look is not achieved.

### SUMMARY OF THE INVENTION

The present invention overcomes the difficulties noted above with respect to the prior art by providing an automatic handle end cutter which severs individual handles from a web of handle material along two axes which provide a handle with no corners and which comes to a point therebetween. When the ends of such a handle are folded under no edge can show from below the handle body and the handle looks complete and finished when sewn on the mattress border.

The automatic handle end cutter feeds a length of end material into a cutting station wherein the corners of the handle ends are removed by two cutters. The cutters cut at angles leaving the end pointed with no corners. Since an continuous web of handle material is used, the cutters cut the second end of a first handle while they cut the first end of the next sequential handle. A shuttle mechanism presents fixed lengths of the handle web to the cutting area where it is clamped adjacent the cutting area. A first cutter traverses the cutting area making a first cut through a first handle and the next sequential handle. The first cutter returns to it initial position at which time the second cutter is activated to make the second cut through the first handle and next sequential handle. As the second cutter return to its initial position an eject cylinder ejects the now fully severed first handle. The shuttle now brings the next sequential handle second end into the cutting area. It is an object of this invention to provide an automatic handle end cutter.

It is an object of this invention to provide an automatic handle end cutter which cuts the corners of each end.

It is an object of this invention to provide a cloth handle which can be installed to a mattress border without unsightly corners extending from below the main handle body when sewn to a mattress border.

It is an object of the invention to provide an automatic handle end cutter which is simple to construct and easy to use.

Other objects and features of the invention will be pointed out in the following description and claims and illustrated in the accompanying drawings, which disclose, by way of example, the principles of the invention, and the best mode which is presently contemplated for carrying them out.

### BRIEF DESCRIPTION OF THE DRAWINGS

In the drawings in which similar elements are given similar reference characters:

FIG. 1 is a top right perspective view of an automatic handle end cutter constructed in accordance with the concepts of the invention with a handle severed along a first end.

FIG. 2 is a top plan view of the cutter device of FIG. 1 with a handle advance to be severed at a second end.

FIG. 3 is a fragmentary, top plan view, partly in section, of the cutting area of the cutter device of FIG. 1.

FIG. 4 is a fragmentary, side elevational view, partially in section, of the cutting device of FIG. 3 taken along the lines 4-4.

FIG. 5 is a top plan view of the cutting device of FIG. 1 showing the movement of a first cutter.

FIG. 6 is a top right perspective view of a completed handle according to the concepts of the invention showing the removed portions in phantom line.

### DESCRIPTION OF THE PREFERRED EMBODIMENT

Turning to FIG. 6 there is shown a completed handle 10 with a body portion 12 ending in end portions 14 and 16. Cut edges 18, 20 of end portion 14 form a point 22 while cut edges 24, 26 of end portion 16 form a point 28. When end portions 14 and 16 are folded under body portion 12 no corners can extend beyond the width of body portion 12.

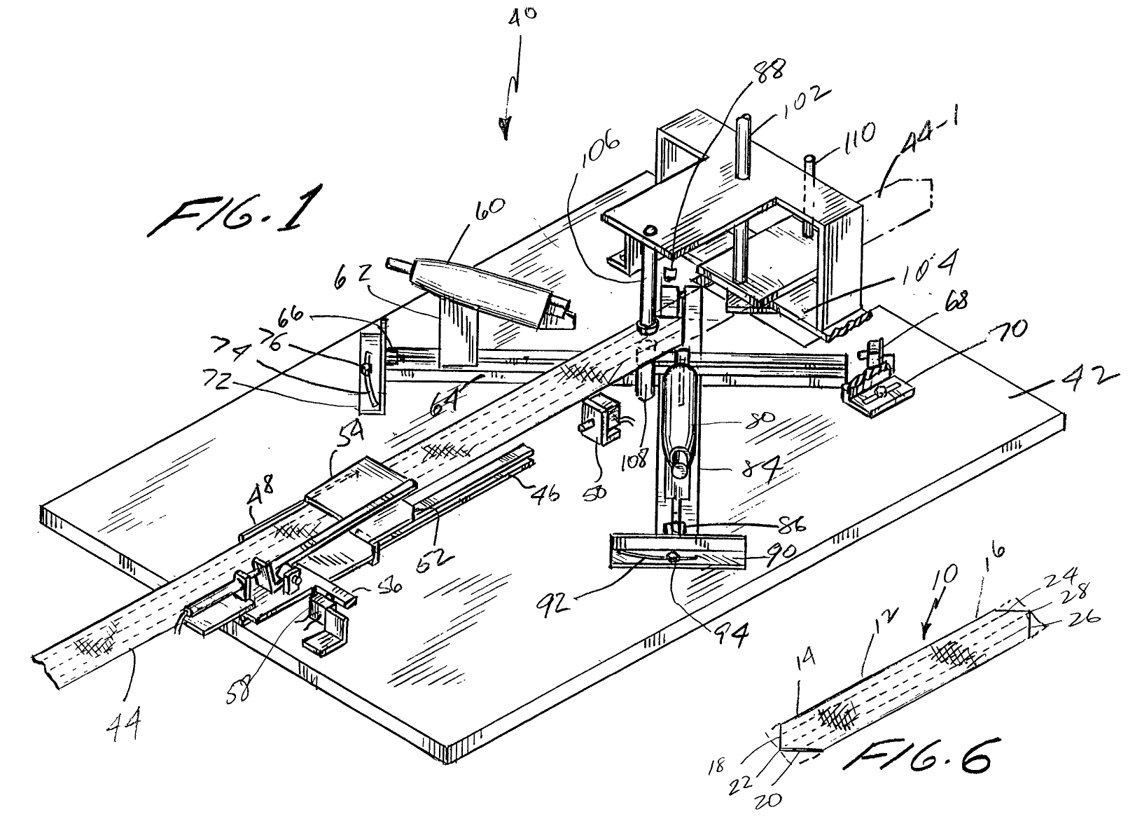

Referring now to FIGS. 1 to 5, an automatic handle end cutter 40 constructed in accordance with the concept of the invention is shown. A table 42 supports and positions the components of the cutter 40. The handle material is presented in a continuous web 44 from a spool of such material supported in a suitable yoke (not shown) as is well known in the art. A track 46 supports and guides a shuttle clamp 48 which advances the web 44 into the cutting area on its forward stroke and non-engagingly slips over the web 44 on its return stroke. It should be understood that shuttle clamp 48, the cutters, the clamps and the ejector are operated by pneumatic cylinders as is well known in the art and the operations of these devices in controlled by limit switches. For example, limit switch 50 permits shuttle clamp 48 advance along track 46 until the front edge 52 of the shuttle clamp 48 strikes limit switch 50. This places the end of the uncut web 44 in the cutting area and unlocks the clamp plate 54 so that is can ride over the web 44 on its return stroke. The return stroke is completed when the arm 56 on the shuttle clamp 48 engages the limit switch 58 which also operates to close clamp plate 54 to grip the web 44.

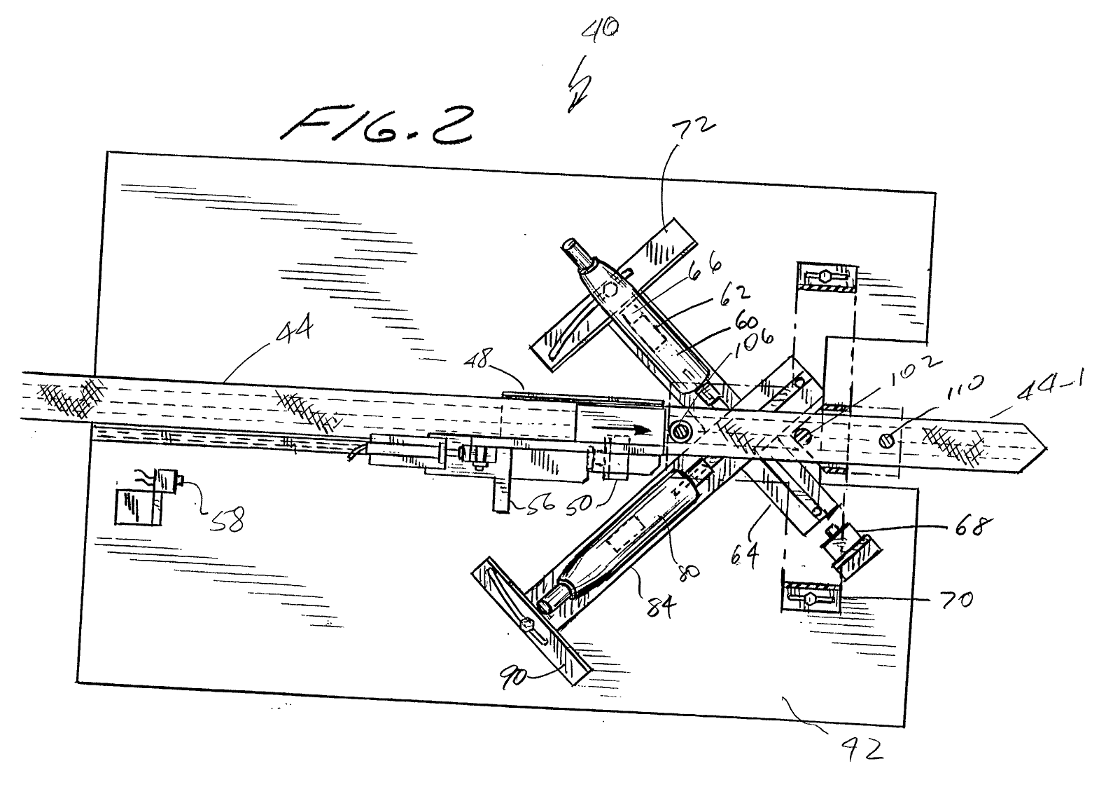

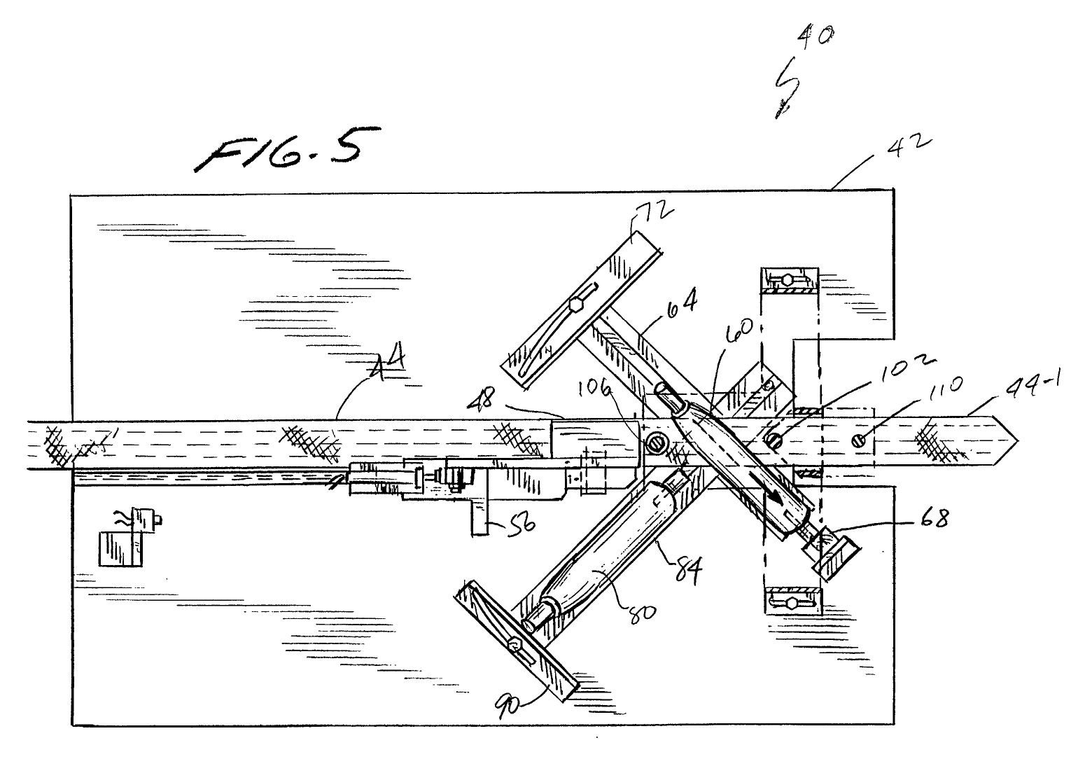

A first cutter 60 may be an available rotary knife, such as a or may be a non-rotary knife such as a . The cutter 60 ride on a track 64 from an initial position against limit switch 66 to a final position against limit switch 68 mounted on bracket 70 to table 42 (see FIG. 5). The limit switch 68 causes the first cutter 60 to reverse direction and return to its position against limit switch 66 (see FIG. 2) at which time cutter 60 is turned off. A support 62 positions the cutter 60 blade 61 at the correct angle and spacing above the web 44 in the cutting area. The track 64 ends in a bracket 72 which contains a slot 74 which received fastener 76. It this manner the track 64 can be rotated about its end adjacent limit switch 68 and a desired cutting angle selected after which fastener 76 is tightened to fix the track 64 angle.

A second cutter 80 which may be a rotary knife or a non-rotary knife as set forth above with respect to cutter 60 has a support 82 which travels along track 84 between a limit switch 86 at the start of its forward travel to a limit switch 88 at the end of such forward travel. When the pneumatic cylinder (not shown) is operated by a controller the second cutter 80 starts from the position in contact with limit switch 86, as shown in FIGS. 2 and 5, and moves until support 82 engages limit switch 88 at which time the travel of cutter 80 reverses until limit switch 86 is engaged at which point the cutter 80 is stopped and turned off. Track 84 is also fitted with a bracket 90 having a slot 92 and is fixed by a fastener 94. Thus, track 84 can also be adjusted for its cutting path. Although the cutting paths for first cutter 60 and second cutter 80 extend at about 45° to the web 44 and other angles could be employed.

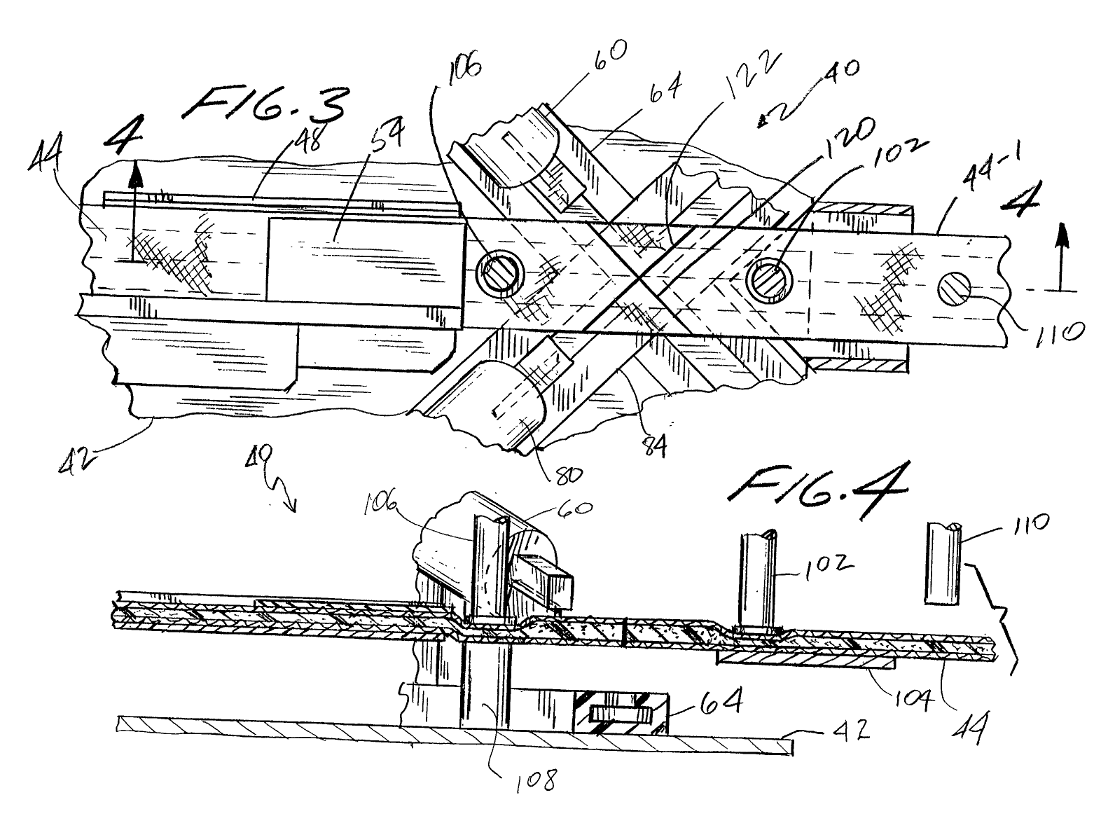

A clamp and ejection assembly 100 is placed on table 42 aligned with the track 46. When the web 44 is moved to the position shown in FIGS. 3 and 4 the first handle 44-1 is in the assembly 100 and clamp 102 is energized to clamp handle 44-1 against shelf 104 of the assembly 100. A clamp 106 is energized to clamp the second handle 44-2 against a support block 108 fixed to the table 42 near the crossing of tracks 64 and 84. In this manner, the end 14 of handle 44-1 and the end 16 of handle 44-2 are clamped on both sides of the cutter tracks 64 and 84. Cutting can then proceeds without any shifting of the handle web 44. Once the cutting is completed the clamps 102 and 106 are released and the ejector cylinder 110 is operated. A plunger (not shown) presses on the severed web 44-1 and causes it to fall into a hopper (not shown).

The automatic handle end cutter 40 operates in the following manner. The end of a web 44 of handles is fed over the shuttle clamp 48 and fixed in place by the clamp plate 54. The start button (not shown) is depressed and the shuttle clamp moves along track 46 towards the cutting area. In that the exact length is not fixed at the beginning of the web 44 nor is the condition of a first end 14 known, the end section is severed in the first cuts and discarded. In all subsequent cycles of operation a known amount of web 44 is played out. Clamps 102 and 106 are disengaged and the shuttle clamp 48 places a length of web 44 in the cutting area and over the shelf 104 of the clamping and ejector assembly 100. This continues until leading edge 52 of shuttle clamp 48 engages limit switch 50. This stops the movement of the shuttle clamp 48 and applies the clamps 102 and 106. Clamp 102 clamps web 44 to the shelf 104 of assembly 100 while clamp 106 clamps web 44 to support block 108 (see FIG. 4) The clamping plate 54 is released and the shuttle clamp 48 moves to limit switch 58 where it remains until the start of the next cycle. The clamp plate 54 is spaced from the remainder of the shuffle clamp 48 so that it can pass over the web 44 without engagement. The clamps 102 and 106 are now operated to fix the web 44 with respect to the cutting area. First cutter 60 is activated and travels along track 64 across the web 44 on the line 120. This line 120 extends across corner 20 of handle 1 and 24 of handle 24 of handle 2. The cutter 60 engages the limit switch 68 and reverses its direction until it engages limit switch 66 at which it stops and turns off. The second cutter 80 is now operated along track 84 and cuts along line 122 until it engages limit switch 88 at which time it reverses and travels until it engages limit switch 86 and turns off.

The clamps 102 and 106 are opened and the ejector cylinder 110 operated to eject the first handle 44-1. The cycle just described begins again.

While there have been shown and described and pointed out the fundamental novel features of the invention as applied to the preferred embodiment as is presently contemplated for carrying them out, it will be understood that various omissions and substitutions and changes of the form and details of the device illustrated and in its operation may be made by those skilled in the art, without departing from the spirit of the invention.

We claim:

1. An automatic handle end cutter for severing individual handles from a web of handle material and configuring the ends of such individual handles comprising:
a) a shuttle clamp for gripping a web of handle material and selectively advancing a portion thereof into a cutting area;
b) a first cutter movable along a first path into engagement with a web to sever an individual handle from said web of handle material and configure certain portions of a cut end; and
c) a second cutter movable along a second path crossing said first path at a cutting area to configure other potions of said cut end.

2. An automatic handle end cutter as defined in claim 1, wherein said first path and said second path cross at substantially right angles.

3. An automatic handle end cutter as defined in claim 1, further comprising:
first clamp means for gripping a first individual handle during cutting by said first and second cutters.

4. An automatic handle end cutter as defined in claim 3, further comprising:
second clamp means for gripping a second individual handle directly adjacent said first individual handle during cutting by said first and second cutters.

5. An automatic handle end cutter as defined in claim 1, wherein said first cutter is a rotary knife cutter.

6. An automatic handle end cutter as defined in claim 5, wherein said second cutter is a non-rotary knife cutter.

7. A automatic handle end cutter as defined in claim 5 wherein said second cutter is a rotary knife cutter.

8. An automatic handle end cutter as defined in claim 1, wherein said first cutter is a non-rotary knife cutter.

9. An automatic handle end cutter as defined in claim 8, wherein said second cuter is a non-rotary knife cutter.

10. An automatic handle end cutter as defined in claim 8, wherein said second cutter is a rotary knife cutter.
